(19) United States
(12) Patent Application Publication
(10) Pub. No.: US 2019/0111591 A1
(43) Pub. Date: Apr. 18, 2019

(54) METHOD AND DEVICE FOR MAINTAINING AN INNER DIAMETER OF A PLASTIC CONTAINER

(71) Applicant: GRAHAM PACKAGING COMPANY, L.P., Lancaster, PA (US)

(72) Inventors: Scott E. Bysick, Perrysburg, OH (US); John E. Denner, York, PA (US); Justin A. Howell, Mechanicsburg, PA (US)

(73) Assignee: GRAHAM PACKAGING COMPANY, L.P., Lancaster, PA (US)

(21) Appl. No.: 15/786,241

(22) Filed: Oct. 17, 2017

(51) Int. Cl. B29C 33/76; B29C 49/06; B29C 49/20; B29C 49/48; B29C 33/04; B65D 83/14

(52) U.S. Cl. CPC B29C 33/76; B29C 49/06; B29C 49/20; B29C 49/48; B29C 2791/007; B65D 83/14; B29C 2049/065; B29C 2049/2026; B29C 33/04

(57) ABSTRACT

Methods and devices for manufacturing plastic preforms and plastic containers are provided. Methods of manufacturing a plastic preform having an inner undercut include forming a preform of plastic in amorphous state and inserting a plug within the mouth of the preform. The plug includes an upper plug member and an expandable element, the expandable element having an initial outer diameter in plan view with the plug in an initial condition and a deployed outer diameter in plan view with the plug in a deployed condition. Methods further include deploying the plug to the deployed condition with the expandable element positioned to engage a side wall proximate the inner undercut and crystallizing the plastic of the preform along the finish portion.

### BACKGROUND OF THE DISCLOSED SUBJECT MATTER

### Field of the Disclosed Subject Matter

The disclosed subject matter relates to methods and devices for manufacturing a plastic preform having an inner undercut.

### Description of the Related Art

Pressure containers can be used to store and dispense pressurized contents, such as aerosol mixtures and the like. Pressure containers commonly must be capable of withstanding internal pressures on the magnitude of 40 to 200 psi. As such, pressure containers have conventionally been fabricated from metal—typically as a cylindrical tube having upper and lower end closures. The bottom end closure can be shaped as a concave dome to withstand pressures, and the upper end closure typically includes a manually actuatable valve for dispensing the pressurized aerosol contents of the container. However, metallic containers have certain inherent disadvantages, such as a tendency to rust over time and to scratch surfaces with which they may come into contact.

Attempts have been made to develop plastic pressure containers. However, the high internal pressures for pressure containers are significantly greater than pressures that are typically encountered in other packaging applications for which plastic material has been used, such as the packaging for unpressurized liquids. Accordingly, design considerations for plastic pressure containers are significantly different than for lower pressure packaging applications such as plastic beverage containers. For example, a plastic pressure container for aerosols or the like must provide a surface on which the valve can be secured to the container in a manner that is capable of withstanding the high internal pressures. An example of a plastic pressure container for storing and dispensing an aerosol mixture is provided in U.S. Patent Publication No. US2013/0082074, which is incorporated herein in its entirety.

A variety of plastic materials are used for forming containers. For example, a plastic container can be formed from an injection-molded “preform” made of polyethylene terephthalate (PET), as is known in the art. The preform has a finish portion with an upper rim that generally should remain unchanged so as to define an opening or mouth of the container. The remainder of the preform is molded by a reheat stretch blow molding process to form the container body. While PET may be suitable for aerosol applications, it is susceptible to stress cracking in the finish portion while under pressurization. In addition, the finish portion of such containers has a tendency to deform when the container is pressurized, possibly resulting in a loss of sealing integrity between the container and the aerosol dispensing closure.

Furthermore, for metal aerosol containers, it is considered preferable to mount the valve assembly to an inside surface of the upper portion of the container. An inside seal can provide mechanical advantages not achieved by an outside seal. However, providing an inside seal on plastic aerosol containers has been considered impractical because of the difficulty of mounting a valve assembly to the inner surface of the finish portion of a blow molded plastic container. That is, the inner surfaces of the finish portion of conventional reheat stretch blow molded containers tend to be smooth, with no features that would enable a valve assembly to gain the necessary purchase in order to prevent dislodgement. Conventional techniques for the manufacture of preforms are not suitable to accurately fabricate an inner surface with a ledge or undercut to support such a valve assembly and maintain its shape during the fabrication process.

There thus remains a continued need for improved methods and devices for maintaining an inner diameter, such as for an undercut, of a plastic container. The subject matter disclosed herein satisfies these and other needs.

### SUMMARY OF THE DISCLOSED SUBJECT MATTER

The purpose and advantages of the disclosed subject matter will be set forth in and are apparent from the description that follows, as well as will be learned by practice of the disclosed subject matter. Additional advantages of the disclosed subject matter will be realized and attained by the methods and devices particularly pointed out in the written description and claims hereof, as well as from the appended drawings.

To achieve these and other advantages and in accordance with the purpose of the disclosed subject matter, as embodied and broadly described, the disclosed subject matter includes a method of manufacturing a plastic preform having an inner undercut that includes forming a preform of plastic in amorphous state, the preform comprising a finish portion defining a mouth, the finish portion having a side wall with a first inner diameter in plan view and an inwardly-projecting rib with a second inner diameter in plan view less than the first inner diameter to define an inner undercut therebetween. The method further includes inserting a plug within the mouth of the preform, the plug having an initial condition and a deployed condition, wherein the plug comprises an upper plug member and an expandable element, the expandable element having an initial outer diameter in plan view with the plug in the initial condition and a deployed outer diameter in plan view with the plug in the deployed condition, the initial outer diameter being less than the second inner diameter and the deployed outer diameter being equal to or greater than the second inner diameter. The method further includes deploying the plug to the deployed condition with the expandable element positioned to engage the side wall proximate the inner undercut and crystallizing the plastic of the preform along the finish portion.

As embodied herein, the plug can further include a shaft extending from the upper plug member, wherein the expandable element is disposed on the shaft. The expandable element can include an expandable ring. For example, the plug can further include a lower plug member, the upper plug member and the lower plug member being moveable relative to each other, wherein the expandable ring is disposed so as to be compressed between the upper plug member and the lower plug member with the plug in the deployed condition. Alternatively or additionally, the expandable element can include a plurality of hinged members disposed around a circumference of the expandable element and mounted for pivotal movement between an initial position and a deployed position. Each hinged member has an engagement end and an actuation end. For example, the plurality of hinged members can be activated by the upper plug member acting on the activation ends to pivot the hinged members to the deployed position. The engagement ends of the hinged members can be configured to collectively define a generally continuous surface having the deployed outer diameter in the deployed position. For example, a first set of hinged members can have engagement ends with outwardly tapered side surfaces and a second set of hinged members can have engagement ends with inwardly tapered side surfaces to cooperate with the side surfaces of the first set of hinged members. Additionally or alternatively, an expandable ring can be disposed over the engagement ends of the hinged members, the expandable ring defining the initial outer diameter with the plug in the initial condition and the deployed outer diameter with the plug in the deployed condition. The plug further includes an actuator to change or move the plug from the initial condition to the deployed condition.

For further illustration, the inwardly-projecting rib can be proximate an upper edge of the finish portion. The inner undercut can have a depth defined between the first inner diameter and the second inner diameter. For example, and not limitation, the inner undercut can have a radiused surface extending from the side wall in cross sectional side view, and the expandable element can have a corresponding radius in cross sectional side view with the plug in the deployed condition to engage the radiused surface. Alternatively, the inner undercut can have a lower surface extending from and defining an angle relative to the side wall in cross sectional side view, and the expandable element can have a corresponding angle in cross sectional side view with the plug in the deployed condition to engage the lower surface and the side wall. As embodied herein, the deployed outer diameter of the expandable element can be at least equal to the first inner diameter.

As embodied herein, the plastic of the preform can include polyethylene terephthalate (PET), polyethylene naphthalate (PEN), polyethylene furanoate (PEF), or a combination thereof. The upper plug member and the expandable element can each be made of a material compatible with a pressure and a temperature used for crystallizing the plastic of the preform. For example, and not limitation, the upper plug member can be made of polyether ether ketone (PEEK), ultra-high-molecular-weight polyethylene, aluminum, and/or stainless steel. For further example, and not limitation, the expandable ring can be made of rubber and/or silicone.

As embodied herein, the plug can further include a lower plug member and the preform can further comprise a hollow body portion extending from the finish portion, the body portion having an inner cross dimension in plan view less than the first inner diameter of the side wall of the finish portion; and further wherein at least a portion of the lower plug member extends into the hollow body portion when the plug is inserted into the mouth of the preform. At least a portion of the lower plug member therefore has an outer diameter less than the inner cross dimension of the hollow body portion. The side wall can have a crystallized first inner diameter after crystallizing the plastic of the preform, the crystallized first inner diameter being within 10% of the first inner diameter before crystallizing the plastic.

In accordance with another aspect of the disclosed subject matter, a method of manufacturing a plastic container having an inner undercut includes forming a preform of plastic in amorphous state, the preform comprising a finish portion defining a mouth, the finish portion having a side wall with a first inner diameter in plan view and an inwardly projecting rib with a second inner diameter in plan view less than the first inner diameter to define a an inner undercut therebetween, the preform further comprising a hollow body portion extending from the finish portion and inserting a plug within the mouth of the preform, the plug having an initial condition and a deployed condition. The plug includes an upper plug member and an expandable element. The expandable element has an initial outer diameter in plan view with the plug in the initial condition and a deployed outer diameter in plan view with the plug in the deployed condition, the initial outer diameter being less than the second inner diameter and the deployed outer diameter being equal to or greater than the second inner diameter. The method further includes deploying the plug to the deployed condition with the expandable element positioned to engage the side wall proximate the inner undercut, crystallizing the plastic of the preform along the finish portion, and blow molding the hollow body portion of the preform to form a container body portion.

As embodied herein, the side wall can have a crystallized first inner diameter after crystallizing the plastic of the preform, the crystallized first inner diameter being maintained within 10% of the first inner diameter before crystallizing the plastic. The blow molding can include a reheat stretch blow molding process. The method can further include securing a valve assembly to the finish portion in engagement with the inner undercut.

In accordance with yet another aspect of the disclosed subject matter, a plug for maintaining an inner diameter of a plastic container having an inner undercut during crystallization is also provided. The plug includes an upper plug member and an expandable element having an initial outer diameter in plan view with the plug in an initial condition and a deployed outer diameter in plan view with the plug in a deployed condition, the initial outer diameter being less than the deployed outer diameter. The plug further includes an actuator to change the plug from the initial condition to the deployed condition. The upper plug member and the expandable element are each made of a material compatible with a temperature and a pressure used for crystallizing a plastic selected from the group consisting of polyethylene terephthalate (PET), polyethylene naphthalate (PEN), polyethylene furanoate (PEF), or a combination thereof.

It is to be understood that both the foregoing general description and the following detailed description and drawings are examples and are provided for purpose of illustration and not intended to limit the scope of the disclosed subject matter in any manner.

The accompanying drawings, which are incorporated in and constitute part of this specification, are included to illustrate and provide a further understanding of the devices of the disclosed subject matter. Together with the description, the drawings serve to explain the principles of the disclosed subject matter.

### BRIEF DESCRIPTION OF THE DRAWINGS

The subject matter of the application will be more readily understood from the following detailed description when read in conjunction with the accompanying drawings, in which:

FIG. 1 is a perspective view of an exemplary plug for maintaining an inner diameter of a plastic container having an inner undercut in accordance with the disclosed subject matter, with a cam-type actuator for purpose of illustration only.

FIG. 2 is a wireframe side view of the plug of FIG. 1 engaged with a plastic preform.

FIG. 3 is an exploded perspective view of the plug and plastic preform of FIG. 2.

FIG. 4A is an image of an exemplary plug of FIG. 1 with a lower plug portion having a reduced outer diameter in accordance with the disclosed subject matter.

FIG. 4B is an image of the exemplary plug of FIG. 4A engaged with a partial cutaway of a preform.

FIG. 5 is an enlarged cross-sectional side detail of an exemplary plug in the deployed condition and engaged with a preform.

FIG. 6 is an image of another exemplary plug for maintaining an inner diameter of a plastic container in accordance with the disclosed subject matter.

FIG. 7A is a wireframe cross-sectional side view of an exemplary plug for maintaining an inner diameter of a plastic container having an inner undercut in accordance with the disclosed subject matter with a hinged member actuator, wherein the plug is in the initial condition.

FIG. 7B is a wireframe cross-sectional side view of an exemplary plug for maintaining an inner diameter of a plastic container having an inner undercut in accordance with the disclosed subject matter with a hinged member actuator, wherein the plug is in the deployed condition.

FIG. 7C is a wireframe cross-sectional plan view taken along line c-c of the plug of FIG. 7A to illustrate the representative positions of the engagement ends of each hinged member with the plug in the initial condition.

FIG. 7D is a wireframe cross-sectional plan view taken along line d-d of the plug of FIG. 7B to illustrate the representative positions of the engagement ends of each hinged member with the plug in the deployed condition.

FIG. 8A is an image of the plug shown schematically in FIG. 7A, wherein FIG. 8A shows the plug in the initial condition.

FIG. 8B is an image of the plug shown schematically in FIG. 7B, wherein FIG. 8B shows the plug in the deployed condition.

FIG. 9 is an illustration of the relevant dimensions of an exemplary plastic preform as described in Example 1.

FIG. 10 is a cross-sectional side view of a plug in accordance with the disclosed subject matter having a square O-ring.

FIGS. 11A-11D are images of plastic preforms after four different processing methods, wherein FIG. 11A shows a plastic preform after molding, but prior to crystallization, FIG. 11B shows a plastic preform that has been crystallized using a conventional Beford Plug Casting method, FIG. 11C shows a plastic preform that has been crystallized using a plug having an O-ring with a round cross-section in accordance with the disclosed subject matter, and FIG. 11D shows a plastic preform that has been crystallized using a plug having an O-ring with a square cross-section in accordance with the disclosed subject matter.

### DETAILED DESCRIPTION

Reference will now be made in detail to embodiments of the disclosed subject matter, examples of which are illustrated in the accompanying drawings. The disclosed subject matter will be described in conjunction with the detailed description of the system.

As disclosed herein, the methods and devices disclosed herein can be used for maintaining an inner diameter of a preform or plastic container having an inner undercut, e.g., the neck finish portion of a plastic pressure container, during crystallization. As the plastic container is formed, and particularly during crystallization, the diameter of the container can contract. As such, it is desirable to provide a support in order to maintain a desired inner diameter during the fabrication process.

In accordance with the disclosed subject matter, a method of manufacturing a plastic preform having an inner undercut includes forming a preform of plastic in amorphous state, the preform comprising a finish portion defining a mouth, the finish portion having a side wall with a first inner diameter in plan view and an inwardly-projecting rib with a second inner diameter in plan view less than the first inner diameter to define an inner undercut therebetween. The method further includes inserting a plug within the mouth of the preform, the plug having an initial condition and a deployed condition, wherein the plug comprises an upper plug member and an expandable element having an initial outer diameter in plan view with the plug in the initial condition and a deployed outer diameter in plan view with the plug in the deployed condition, the initial outer diameter being less than the second inner diameter and the deployed outer diameter being equal to or greater than the second inner diameter. The method further includes deploying the plug to the deployed condition with the expandable element positioned to engage the side wall proximate the inner undercut and crystallizing the plastic of the preform along the finish portion.

As embodied herein, the preform includes a finish portion with an upper rim that defines an opening or mouth of the container and generally remains unchanged during subsequent manufacturing, e.g., when the preform is molded to form a container body. The finish portion of the preform includes an inner undercut. For example, and not limitation, the finish portion can have a side wall with a first inner diameter in plan view and an inwardly-projecting rib with a second inner diameter in plan view that is less than the first inner diameter. As such, the inner undercut can be defined between the side wall and the rib. The inner undercut can be radiused or angular relative to the side wall. As embodied herein, the inwardly-projecting rib can be proximate an upper edge of the finish portion, i.e., the mouth of the finish portion. The preform embodied herein further includes a hollow body portion extending from the finish portion. The inner diameter of the hollow body portion, when viewed in plan view, can be less than the first inner diameter of the finish portion at the side wall. The preform can be formed in an amorphous state and crystallized later in manufacturing. Suitable materials for the preform include, but are not limited to, polyethylene terephthalate (PET), polyethylene naphthalate (PEN), polyethylene furanoate (polyethylene 2,5-furandicarboxylate or PEF), and blends thereof, including blends with each other or blends with other materials such as isosorbide (e.g., PEIT).

In accordance with the disclosed subject matter, a plug for maintaining an inner diameter of a plastic container having an inner undercut during crystallization is also provided. The plug includes an upper plug member and an expandable element, the expandable element having an initial outer diameter in plan view with the plug in an initial condition and a deployed outer diameter in plan view with the plug in a deployed condition, the initial outer diameter being less than the deployed outer diameter. The upper plug member and the expandable element are each made of a material compatible with a temperature and a pressure used for crystallizing a plastic selected from the group consisting of polyethylene terephthalate (PET), polyethylene naphthalate (PEN), polyethylene furanoate (PEF), or a combination thereof.

The plug further includes an actuator to change or move the upper plug member from the initial condition to the deployed condition, and vice versa. For example, the upper plug member can include a shaft extending therefrom and the actuator can move the upper plug member along the shaft toward the expandable element to transition the plug from the initial condition toward the deployed condition and away from the expandable element to transition from the deployed condition toward the initial condition. The plug can optionally further include a lower plug member disposed along the shaft. For example, the lower plug member can be disposed along the shaft such that the expandable element is positioned between the upper plug member and the lower plug member. As such, the actuator can move the upper plug member toward the lower plug member when transitioning the plug from the initial condition to the deployed condition and away from the lower plug member when transitioning the plug from the deployed condition to the initial condition. Alternatively or additionally, the actuator can move the expandable element and/or the lower plug member, with or without movement of the upper plug member relative to the finish portion, to cause the above-described relative movement, e.g., along the shaft. As embodied herein, one or more of the upper plug member, the lower plug member, and the expandable element can be made of a material compatible with conditions (e.g., temperature and pressured) used for crystallizing PET, PEN, and/or PEF. As described in greater detail herein, the actuator can be any suitable mechanism for transitioning the plug from the initial condition to the deployed condition, such as a cam lever, air cylinder, servo motor, thread assembly, gear assembly, hydraulic cylinder, pneumatic cylinder, or a combination of these elements with each other or with one or more additional components.

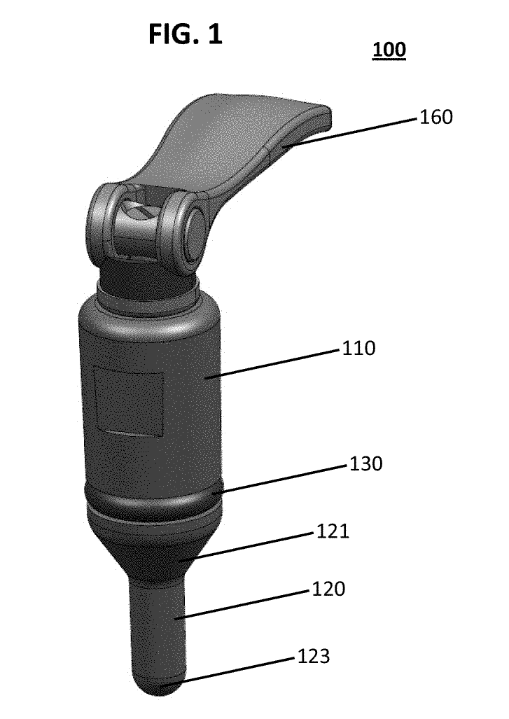

Solely for purpose of illustration, an exemplary embodiment of a plug for maintaining the inner diameter of a preform or plastic container is shown schematically in FIGS. 1-5, wherein the expandable element, e.g., an expandable ring, is configured to be compressed between upper and lower plug portions. The examples herein are not intended to limit the scope of the disclosed subject matter in any manner. Particularly, and as illustrated, the plug 100 includes an upper plug member 110 and a lower plug member 120. The upper plug member 110 and the lower plug member 120 are disposed for relative movement between an initial condition and a deployed condition of the plug. For example, the upper plug member 110 and the lower plug member 120 can be disposed along a shaft. In the initial condition, the upper plug member 110 and the lower plug member 120 can be separated by an initial distance, which can be reduced when the plug transitions to the deployed condition. For example, the upper plug member 110 can be mounted on a shaft extended therefrom for movement toward the lower plug member 120 and/or the lower plug member 120 can be mounted on the shaft for movement toward the upper plug member 110 when the plug transitions or is returned from the initial condition to the deployed condition, or vice versa. The plug can be inserted within the mouth of the preform. The upper plug member 110 can be disposed above the lower plug member 120 and spaced from the lower plug member by the expandable element 130 disposed therebetween.

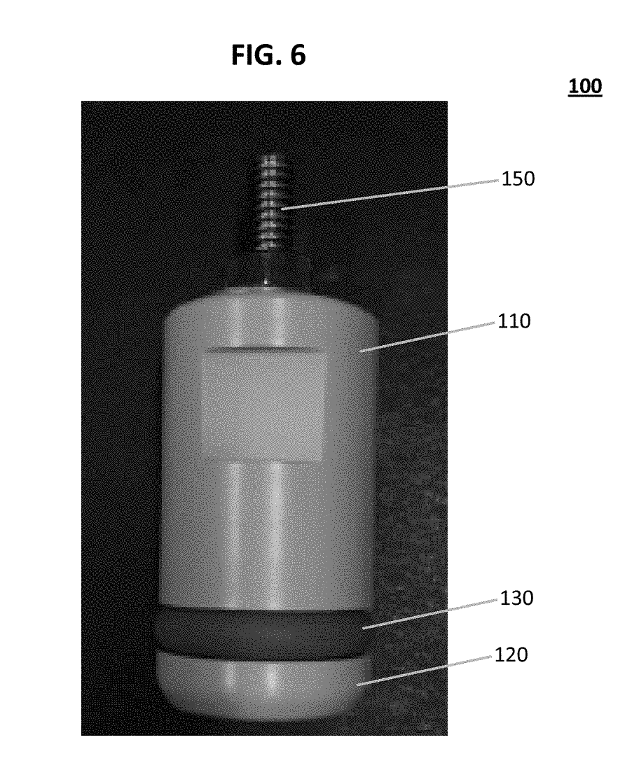

As embodied herein, the upper plug member 110 can be generally cylindrical, as shown in FIG. 1. Alternatively, the upper plug member 110 can have any suitable shape. Similarly, the lower plug member 120 can be funnel-shaped and/or conical to provide an area of reduced cross-section as shown in FIG. 1. For further example, and as embodied herein, the lower plug member can have a cylindrical or other suitable shape. As previously noted, the preform can include a hollow body portion with an inner cross dimension less than the first inner diameter of the finish portion at the side wall. The lower plug member can thus be configured with an outer diameter less than the first inner diameter so as to extend into the hollow body portion when the plug is inserted into the mouth of the preform. As such, the lower plug member can include an upper portion 121 and a lower portion 123, wherein the upper portion has a diameter that can be greater than or equal to a diameter of the lower portion. Alternatively, the lower plug member need not extend into the plastic preform, and can instead be dimensioned to terminate proximate a finish portion of the container, for example, as illustrated in FIG. 6.

The upper plug member 110 and the lower plug member 120 can each be made of any suitable material capable of withstanding the conditions (e.g., temperature and pressure) expected during crystallization of the preform. For example, the upper plug member and the lower plug member can each be made of plastic materials such as polyether ether ketone (PEEK) and ultra-high-molecular-weight polyethylene (UHMW polyethylene) or metal materials such as aluminum and stainless steel. The upper plug member 110 and the lower plug member 120 can be made of the same or different materials. The materials of the upper plug member 110 and the lower plug member 120 can be compatible with the conditions of crystallization of the material of the preform, e.g., PET, PEN, and/or PEF.

As embodied herein, the expandable element 130 can also disposed on the shaft 135, or otherwise disposed relative to the upper plug member 110 and the lower plug member 120, and transitions from an initial outer diameter to a deployed outer diameter as the plug transitions from its initial condition to its deployed condition. As used herein, the initial outer diameter and the deployed outer diameter of the expandable element refer to the maximum outer diameter in plan view, i.e., the horizontal diameter of the expandable element when the plug is in the initial condition and the deployed condition, respectively. For example and not limitation, the expandable element 130 of the exemplary embodiment of FIG. 1 can include an expandable ring that can be compressed between the upper plug member 110 and the lower plug member 120 to transition from the initial outer diameter to the deployed outer diameter, such that the deployed outer diameter is greater than the initial outer diameter.

As embodied herein, the expandable ring can be made of any suitable compressible, flexible, or inflatable material, and can transition from an initial outer diameter to a deployed outer diameter. For example, and not limitation, the expandable ring can include a silicone material and/or a rubber material such as Viton™ or hard Viton™ rubber (both available from The Chemours Company). The material of the expandable ring can be compatible with the conditions (e.g., temperature and/or pressure) of crystallization of the material of the preform, e.g., PET, PEN, or PEF. Additionally, the material of the expandable ring can have good elasticity in order to expand to the deployed outer diameter in the deployed condition while also exerting force on the interior of the preform to support the inner diameter of the inner undercut. Although described as a “ring,” the expandable ring need not be round. For example, and not limitation, the cross-section of the expandable ring can be round, square, rectangular, oval, or have any other suitable shape. As embodied herein, the inner undercut of the preform can have a rounded or radiused surface, i.e., extending from the side wall in cross sectional side view, and the expandable ring can have a corresponding radius in cross sectional side view in order to engage inner undercut. Alternatively, the inner undercut can have a lower surface extending inwardly and defining an angle relative to the side wall in cross sectional side view, and the expandable ring can have a corresponding angle in cross sectional side view in order to engage inner undercut.

When transitioning from the initial outer diameter to the deployed outer diameter, the diameter of the expandable ring can expand by from about 20 thousandths to about 60 thousandths (i.e., about 0.020 inches to about 0.060 inches), or from about 30 thousandths to about 50 thousandths (i.e., about 0.030 inches to about 0.050 inches), or from about 35 thousandths to about 45 thousandths (i.e., about 0.035 inches to about 0.045 inches), or about 40 thousandths (i.e., about 0.040 inches). For further example, the outer diameter of the expandable ring can expand by from about 0.05% to about 1%, or from about 0.1% to about 0.6%, or from about 0.15% to about 0.5% as compared to the initial outer diameter. As used herein, the term “about” or “approximately” means within an acceptable error range for the particular value as determined by a person of ordinary skill in the art, which will depend in part on how the value is measured or determined, i.e., the limitations of the measurement system; for example, “about” can mean a range of up to 20%, up to 10%, up to 5%, and or up to 1% of a given value. The expandable ring can be expanded inherently, for example, based on elastic properties that cause it to compress and expand based on external pressures, e.g., from the upper plug member, the lower plug member, and/or hinged portions of the expandable element. Alternatively, the expandable ring can be inflated or otherwise actuated in order to transition from the initial outer diameter to the deployed outer diameter.

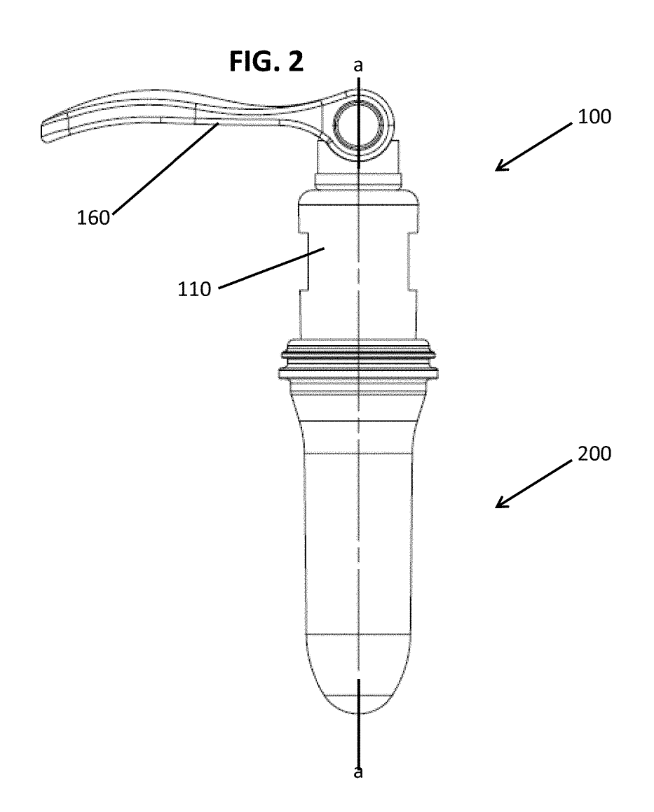

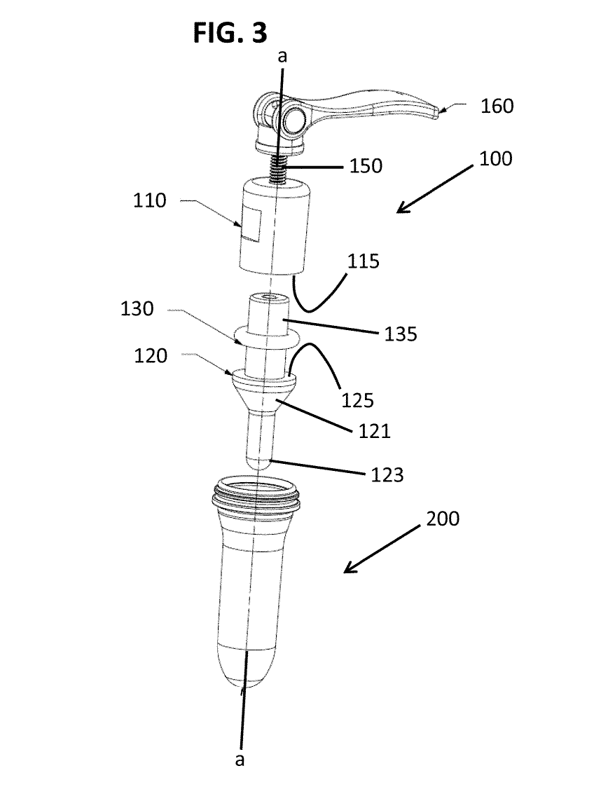

For further illustration, and not limitation, FIG. 3 provides an exploded view of the plug 100 and plastic preform 200 of FIG. 2. As illustrated in FIG. 3, the upper plug member 110, lower plug member 120, and expandable element 130 can be disposed on a shaft 135. The upper plug member 110 and lower plug member 120 can move relative to each other along the shaft 135 to deploy the expandable element 130.

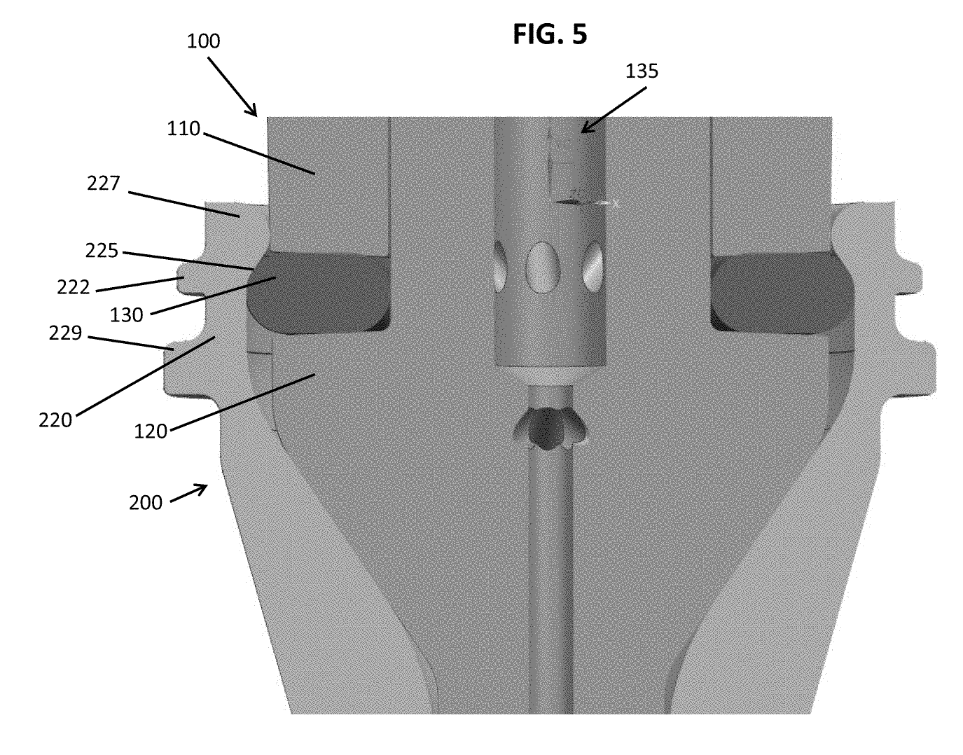

As embodied herein, the upper plug member 110 and lower plug member 120 can be moved relative to each other using any suitable actuator configured to move at least one of the upper plug member 110 and the lower plug member 120 towards each other along the shaft 135. In this exemplary embodiment, the upper plug member 110 is hollow so as to receive the shaft 135 with the shaft extending therefrom. For example, and not limitation, a cam lever 160 can be secured to the shaft 135 by a fastener 150. Such a cam lever 160 is illustrated in FIGS. 1-3 for the purpose of illustration and not limitation. Lowering the cam lever 160 from its initial position will draw one or more of the upper plug member and the lower plug member towards each other along the shaft 135. With the upper plug member 110 seated on an upper rim of the finish portion, the lower plug member 120 will thereby be moved upward toward the upper plug member when the cam lever 160 is moved from the initial raised position to the lowered deployed position. In this manner, the expandable element 130 will be axially compressible between the upper plug member and the lower plug member so as to expand radially toward its deployed outer diameter and engage the side wall of the finish portion, as depicted for example in FIG. 5. Alternatively, another type of actuator can be used to manipulate the upper plug member 110 and lower plug member 120 along the shaft 135, including but not limited to an air cylinder, servo motor, thread assembly, a gear assembly, a hydraulic cylinder, or a pneumatic cylinder.

The actuator, e.g., the cam lever 160, can move the upper plug member 110 and lower plug member 120 toward each other along the shaft 135 from the initial condition toward the deployed condition and away from each other from the deployed condition toward the initial condition. In the deployed condition, the expandable element 130 can be flush with a bottom surface 115 of the upper plug member 110 and/or a top surface 125 of the lower plug member 120, for example, as illustrated in FIG. 1. As such, the expandable element 130, e.g., an expandable ring, can be compressed between the upper plug member 110 and the lower plug member 120 in the deployed condition, as shown for example in FIG. 5.

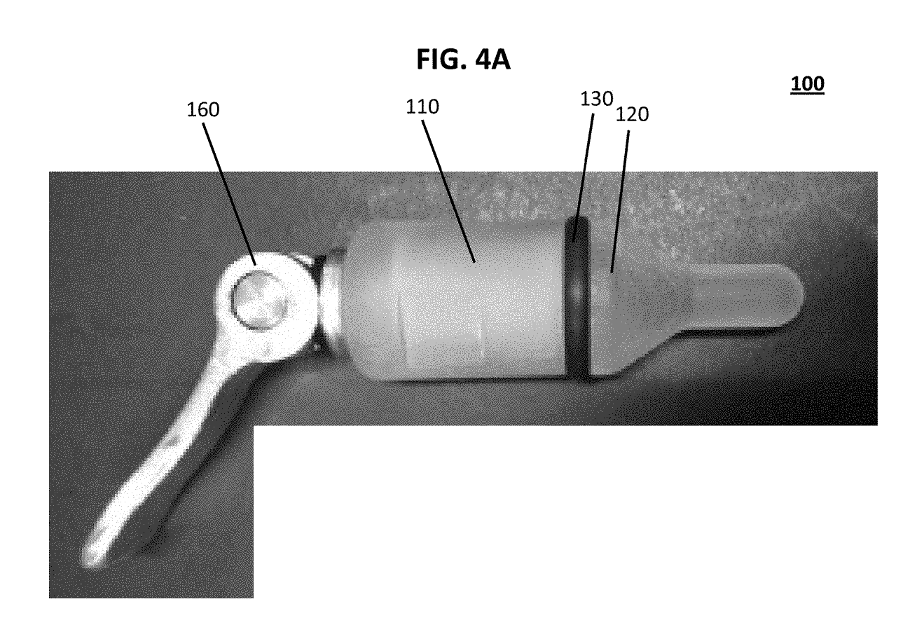

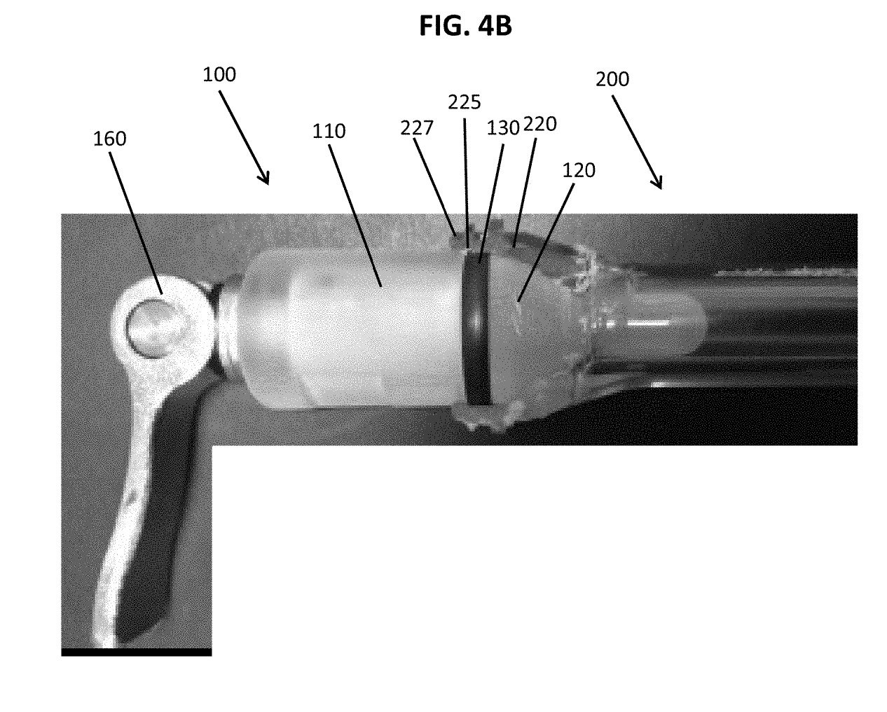

For purpose of illustration, and not limitation, FIG. 4A presents an image of an exemplary embodiment of the plug 100 of FIGS. 1-3, with the cam lever 160 partially deployed to depict the plug 100 in a partially deployed condition with the upper plug member 110 and the lower plug member 120 partially moved toward each other so as to partially compress the expandable element 130 therebetween. By contrast, FIG. 4B presents an image of the exemplary embodiment of the plug 100 of FIG. 4A positioned within a preform with the cam lever 160 fully deployed to depict the plug 100 in the deployed condition with the expandable element compressed between the upper plug member 110 and the lower plug member 120 and having a deployed outer diameter. As depicted in FIG. 4B, the finish portion of the preform is partially cut away to demonstrate the position of the upper plug member on the upper rim of the finish portion and the expandable element deployed proximate the inner undercut for engagement with the side wall.

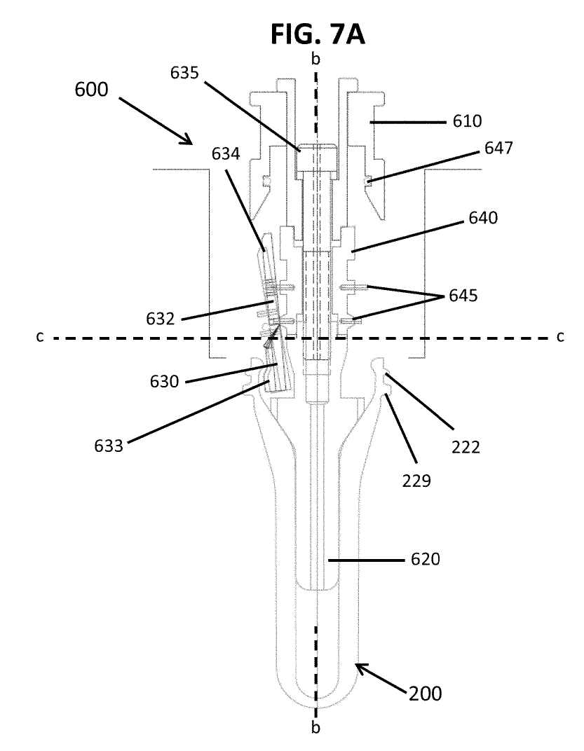

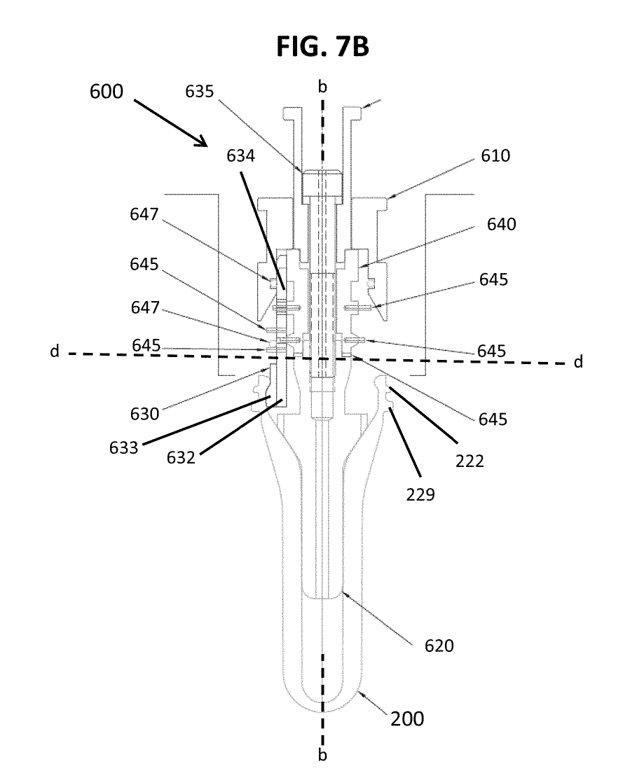

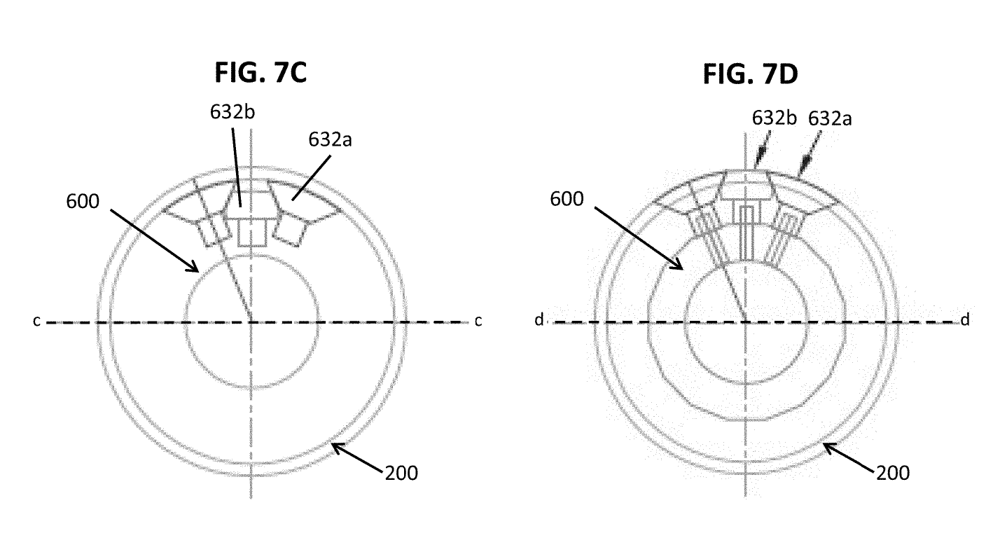

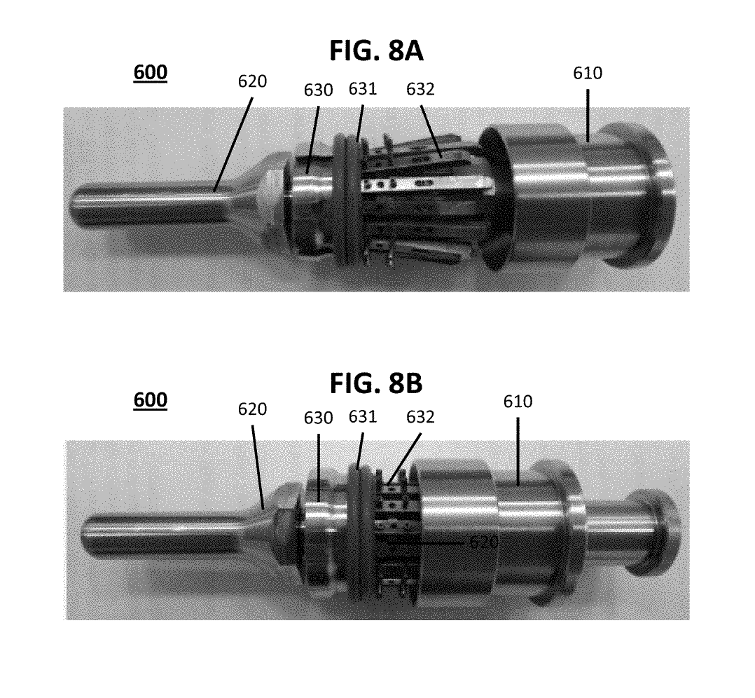

For further illustration, another exemplary embodiment of a plug for maintaining the inner diameter of a preform or plastic container in accordance with the disclosed subject matter herein is shown schematically in FIGS. 7A-7D, wherein the expandable element comprises a plurality of hinged members 632 mounted on a shaft 635 extending from the upper plug member 610 and spaced about a circumference of the expandable element, e.g., around a circumference of the shaft. FIG. 7A shows a schematic cross-sectional side view of the plug 600 in the initial condition whereas FIG. 7B shows a schematic cross-sectional side view of the plug as it transitions from the initial condition towards the deployed condition. Similarly, FIGS. 7C and 7D show schematic cross-sectional plan views along line c-c of FIG. 7A and along line d-d of FIG. 7B with the plug in the initial and deployed conditions, respectively. For additional illustration, FIGS. 8A and 8B provide images of a representative plug having hinged members 632 when the plug 600 is in the initial condition and the deployed condition, respectively. Each hinged member 632 is mounted on the shaft 635 for pivotal movement. The hinged members 632 can each include an engagement end 633 for engagement with the inner diameter of the preform and an opposite actuation end 634. The hinged members 632 are configured to cooperate together, such that the engagement ends 633 collectively define a generally continuous surface having a deployed outer diameter in plan view with the plug 600 in the deployed condition as shown in FIG. 7B and 7D. For example, and as described further below, the upper plug member 610 can be provided with a wedge-like surface to engage the actuator end 634 of the hinged members 632 and thus pivot the engagement end 633 of the hinged members outwardly. As depicted in FIG. 7C and FIG. 7D, the plurality of hinged members 632 can include a first set of hinged members 632a with engagement ends having outwardly tapered side surfaces and a second set of hinged member 632b with engagement ends having corresponding inwardly tapered side surfaces, which cooperate in a wedge-like manner for uniform deployment.

With reference to FIGS. 7A-7B, to transition the plug 100 from the initial condition to the deployed condition, the upper plug member 610 can be moved along the shaft 635 to act upon the actuator ends of the hinged members 632. For example, the upper plug member 610 can be provided with an inner chamfer or wedge to contact a corresponding angled surface of the actuator end of each hinged member 632. In this manner, the hinged members 632 will pivot the engagement ends outwardly to form a substantially continuous surface having a deployed outer diameter. Other suitable configurations can be used to pivot the hinged members. The upper plug member 610 can be actuated by any suitable actuator as known in the art, such as a pneumatic, hydraulic, or mechanical drive assembly, as described above.

As shown in FIGS. 7A-7B, the expandable element 630 can include a plurality of hinged members 632 that pivot when engaged by the upper plug member 610, e.g., engagement ends of the hinged members 632 can pivot outwards upon applied force from the upper plug member 610. The hinged members 632 can be mounted on a circumference of the shaft 635. For example, each hinged member 632 can be connected to a hinge 640 disposed along the shaft 635. As embodied herein, the hinged members 632 can be mounted by one or more O-rings to secure the hinged members against a fulcrum point on the shaft 635. Movement of the hinged members 632 can be guided by one or more pins 645 along the shaft 635. Additionally, an O-ring or the like can be provided on the upper plug member 610, e.g., proximate the actuation ends 634 of the hinged members, to secure the position of the hinged members 632 in the deployed position once the deployed condition is reached.

For further illustration, and with reference to FIGS. 7C-7D, the hinged members 632 can have a variety of suitable shapes and sizes configured to define the expandable element as described. For example, the engagement ends of the hinged members 632 can be configured to form a continuous surface having a deployed outer diameter when the plug is in the deployed condition, as shown in FIG. 7D. Likewise, when the plug is in the initial condition as depicted in FIG. 7C, at least some of the hinged members 632 will define the initial outer diameter. With reference to FIG. 7C, a first set of hinged members 632a can have engagement ends with an outwardly tapered shape, respectively, and an alternating second set of hinged members 632b can have engagement ends with a second shape that is complementary to the outwardly tapered shape of the first set of hinged members 632a. When in the initial condition as shown in FIG. 7C, the second set of hinged members 632b can be disposed radially adjacent to the first set of hinged members 632a. When transitioned to the deployed condition, as shown in FIG. 7D, the second set of hinged members 632b can pivot outwards in a greater radius than the first set of hinged members 632a, and their respective outer surfaces can align to form a substantially continuous surface.

Moreover, as embodied herein, the inner hinged members 632b can assist the outer hinged members 632a outwards such that the resulting continuous circle can have a greater outer diameter than the initial outer diameter of either the inner hinged members 632b and the outer hinged members 632a. For instance, as further illustrated in FIGS. 7C-7D, the diameter of the plug 100 relative to the preform 200 in the initial condition (FIG. 7C) can be less than the diameter of the plug 100 relative to the preform 200 in the deployed condition (FIG. 7D).

In addition to or as alternative to the engagement ends of the hinged members being configured to collectively form a continuous surface, an expandable ring can be provided and disposed about the plurality of hinged members proximate the engagement ends. In this manner, the expandable ring can be expanded radially-outward by deployment for the hinged members, such that the expandable ring defines the initial outer diameter with hinged members in the initial position and the plug in the initial condition, and the expandable ring further defines the deployed outer diameter with hinged members in the deployed position and the plug in the deployed condition.

Unlike the embodiment of FIGS. 1-5, which requires compression of the expandable element between an upper plug member and a lower plug member, the expandable element of the embodiment of FIGS. 7A-7D and 8A-8B does not require such compression. As such, the plug does not require a lower plug member. However, with further reference to FIGS. 7A-7B, the plug 600 can further include a lower plug member 620 disposed along the shaft 635. For example, the expandable element 630 can be disposed between the upper plug member 610 and the lower plug member 620 along the shaft 635. As described in connection with FIGS. 1-4, above, the lower plug member 620 can be funnel-shape and/or conical to provide an area of reduced cross-section, or alternatively can have a cylindrical or other suitable shape. For example, the lower plug member can be configured with an outer diameter that is less than the inner cross dimension of the hollow body portion of the preform 200, and can thus extend into the hollow body portion 200 when the plug 600 is inserted into the mouth of the preform. Alternatively, the lower plug member 620 can terminate proximate a finish portion of the container without extending into the hollow body portion of the preform 200.

As described above, the plug can be used to support and maintain an inner diameter of a plastic container during fabrication, e.g., crystallization. For example, the plug can be deployed to the deployed condition with the expandable element positioned to engage the side wall of the finish portion that is proximate the inner undercut. For the purpose of illustration, and not limitation, FIG. 2 provides an illustration of the plug of FIG. 1 that is inserted into a plastic preform 200. Although the following description is provided with reference to the embodiment of FIG. 2, a person of skill in the art will appreciate that the same techniques and configurations apply to other plugs in accordance with the disclosed subject matter, e.g., the embodiment of FIGS. 7A-7B. As illustrated in FIG. 2, the upper plug member 110, lower plug member 120, and expandable element 130 can be aligned along a vertical axis. As shown in FIG. 2, each of the upper plug member 110 and the lower plug member 120 can have a diameter that is less than a diameter of the rim or upper edge of the plastic container to allow the plug to be inserted into the plastic container, for example, through the neck of the container. When the inner plug member and the outer plug member are in the initial condition, the expandable element 130 can likewise be inserted into the plastic container. However, once inserted, the upper plug member 110 and the lower plug member 120 can transition to the deployed condition, causing the expandable element 130 to transition to its deployed outer diameter in order to support an inner diameter of the container. The deployed outer diameter of the expandable element is at least equal to the diameter of the finish portion at the side wall and proximate the inner undercut. As such, the expandable element 130 is able to support an inner diameter that is greater than a narrower portion of the container, e.g., the mouth of the container. The expandable element 130 can support the side wall at any suitable height relative to the inner undercut, i.e., it need not provide support directly adjacent to the inner undercut. For example, the expandable element 130 can support the side wall at one or more portions of the side wall below the inner undercut. As explained in further detail below, the position of the expandable element 130 relative to the inner undercut can be controlled with other geometry of the plug 100, e.g., the height and/or diameter of the lower plug portion.

The relationship between the plug 100 and the dimensions of a plastic preform 200 will be further understood with reference to FIGS. 4A-4B and 5. For example, FIG. 4B provides a photograph of a plug 100 in accordance with the disclosed subject matter and in which the plug has been inserted into a plastic preform 200. Similarly, FIG. 5 shows a cross-sectional schematic of the plug 100 inserted into a plastic preform 200. FIG. 4A depicts the plug 100 without a plastic preform. As shown in FIGS. 4B and 5, the plastic preform 200 can include a finish portion 220. The finish portion 220 can have a detailed geometry including at least one inner undercut defined by a side wall 225 and an inwardly-projecting rib 227. As embodied herein, the finish portion 220 can further have additional features, such as a support flange 229, to aid in transport and manufacturing of the plastic container, and one or more threads 222 or other closures for the plastic container.

The diameter of the upper plug member 110 can be less than or equal to the inner diameter of the narrowest portion of the finish portion 220 above the inner undercut, i.e., the inwardly-projecting rib 227. As shown in FIG. 4A, the inwardly-projecting rib 227 can be proximate the upper edge and form the mouth of the plastic preform 200, and the upper plug member 110 can have a diameter that is less than that finish portion at the inwardly-projecting rib 227. Similarly, the lower plug member 120 can have a diameter that is less than or equal to the inner diameter at the inwardly-projecting rib 227 and less than or equal to the inner diameter of the narrowest portion of the finish portion 220 below the inner undercut. The lower plug member 120 can be contoured to mimic the shape of the plastic preform 200, and provide additional support to the plastic preform during fabrication. Additionally, a side or bottom portion of the lower plug member 120 can abut the interior geometry of the plastic preform 200, e.g., a narrower portion of the preform below the finish portion. When inserted into the preform 200, the lower plug member 120 can control the depth of the insertion and thereby position the expandable element 130 relative to the inwardly-projecting rib 227 and the side wall 225. Alternatively, other features of the plug can be used to control the depth of insertion, such as features of the upper plug member that engage the top or outer geometry of the preform.

As embodied herein, and with reference to FIG. 4B, the expandable element 130 can initially have an initial outer diameter less than or equal to the inner diameter at the inwardly-projecting rib 227 of the finish portion 220, to allow the expandable element to be inserted through the plastic preform and to the position of the inner undercut. Once in place, the expandable element 130 can transition to a deployed outer diameter that is less than or equal to the inner diameter of the inner undercut and can be positioned to engage the side wall 225 proximate the inner undercut. Even if the deployed outer diameter of the expandable element 130 is less than the diameter of the inner undercut 225, the expandable element should still be capable of supporting the inner diameter of the inner undercut, e.g., by being at least equal to a desired inner diameter of the inner undercut. Thus, the deployed outer diameter of the expandable element 130 can be greater than the diameter of the upper plug member 110 and/or the lower plug member 120.

As previously noted, a method of forming a plastic preform having an inner undercut is provided. The method includes forming a preform 200 of plastic in amorphous state. For example, the plastic perform can be formed by molding plastic material to produce a preform having a finish portion with the desired geometry. The method further includes inserting a plug, for example as described above in connection with FIGS. 1-8, wherein the plug comprises an upper plug member and an expandable element. The method further includes deploying the plug to the deployed condition with the expandable element positioned to engage the side wall proximate the inner undercut of the preform and crystallizing the plastic of the preform along the finish portion.

As embodied herein, during crystallization, the plug can support the inner diameter of the finish portion. For example, and with reference to FIG. 5 for the purpose of illustration only, the upper plug member 110 can support the inwardly-projecting rib 227 of the finish portion and the expandable element 130 can support the side wall 225 proximate the inner undercut. Further, the lower plug member 120 can support the inner surface of the finish portion at one or more points below the inner undercut and can control the height of the upper plug member 110 and expandable element 130 relative to the preform 200. Providing support using the plug of the presently disclosed subject matter can reduce shrinkage at the inner undercut. For example and not limitation, crystallization can result in a crystallized inner diameter that is maintained within about 35%, about 30%, about 25%, about 15%, or about 10% of the inner diameter of the side wall proximate the inner undercut prior to crystallization per side of the finish portion. The depth of the inner undercut per side of the finish portion, as defined by one half of the difference between a first inner diameter taken at the side wall 225 proximate the inner undercut and a second inner diameter taken at the inwardly-projecting rib 227, can range from about 25 thousandths to about 50 thousandths (i.e., about 0.025 inches to about 0.050 inches), or from about 27 thousandths to about 42 thousandths (i.e., about 0.027 inches to about 0.042 inches), or from about 32 thousandths to about 37 thousandths (i.e., about 0.032 inches to about 0.037 inches).

In accordance with another aspect of the disclosed subject matter, a method of manufacturing a plastic container having an inner undercut includes forming a preform of plastic in amorphous state, the preform comprising a finish portion defining a mouth. The finish portion has a side wall with a first inner diameter in plan view and an inwardly projecting rib with a second inner diameter in plan view less than the first inner diameter to define an inner undercut therebetween. The preform further comprises a hollow body portion extending from the finish portion and inserting a plug within the mouth of the preform, the plug having an initial condition and a deployed condition. The plug includes an upper plug member and an expandable element. The expandable element has an initial outer diameter in plan view with the plug in the initial condition and a deployed outer diameter in plan view with the plug in the deployed condition, the initial outer diameter being less than the second inner diameter and the deployed outer diameter being equal to or greater than the second inner diameter. The method further includes deploying the plug to the deployed condition with the expandable element positioned to engage the side wall proximate the inner undercut, crystallizing the plastic of the preform along the finish portion, and blow molding the hollow body portion of the preform to form a container body portion.

As embodied herein, the blow molding can be performed using a reheat stretch blow molding process. For example, in such a blow molding process, the blow molding apparatus can feature an interior clamp that engages the interior of the preform to transport and secure the preform during blow molding. This interior clamp can be adapted to accommodate the geometry of the preform in order to conform to the shape of the preform. For example, the interior clamp can include a circumferential recess corresponding to the inwardly-projecting rib of the preform.

### EXAMPLES

The presently disclosed subject matter will be better understood by reference to the following Examples. These Examples are merely illustrative of the presently disclosed subject matter and should not be considered as limiting the scope of the subject matter in any way.

### Example 1

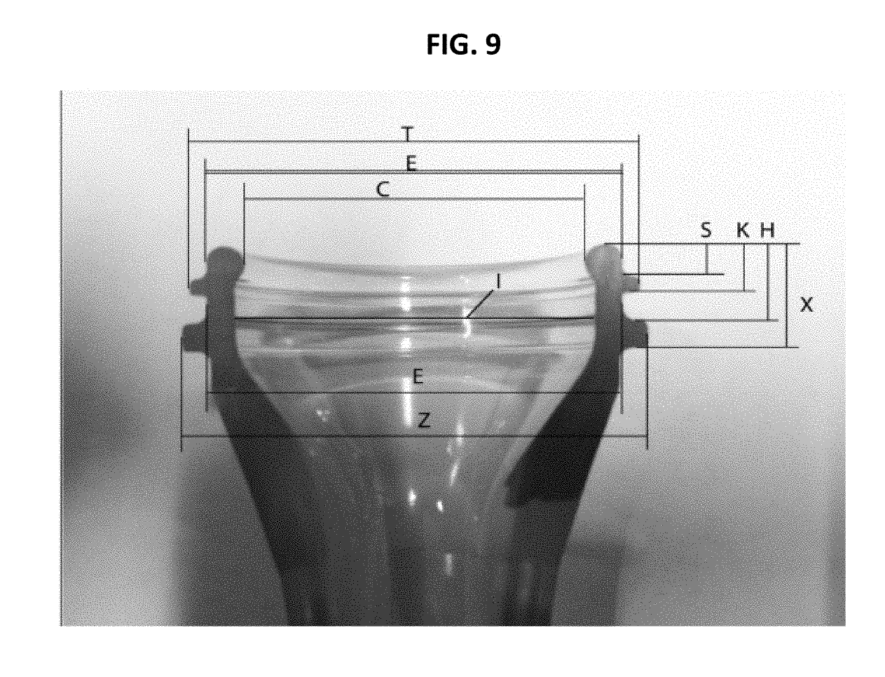

In this Example, plastic preforms were crystallized using conventional methods, and using different embodiments of plugs in accordance with the disclosed subject matter. Variations in the inner diameter were measured to compare these methods. Reference will be made to various dimensions of the plastic preforms, which are depicted in FIG. 9.

First, plastic preforms were prepared, having the nominal dimensions shown in Table 1. Table 1 further provides descriptions of the dimensions referenced in this Example, as illustrated in FIG. 9.

TABLE 1

| | | Nominal |
|---|---|---|
| Dimension | Description | Design (in.) |
| T-avg | Outer diameter at outer thread | 1.326 |
| T-ovality | Deviation from circular at outer thread | 0.000 |
| E-avg | Outer diameter below outer thread | 1.226 |
| F-avg | Outer diameter at upper rim | 1.226 |
| (E above T) | | |
| K-avg | Height between bottom of outer thread | 0.160 |
| | and upper rim | |
| Z-avg | Outer diameter at outer flange | 1.374 |
| H-avg | Height between top of outer flange and | 0.243 |
| | upper rim | |
| X-avg | Height between bottom of outer flange | 0.340 |
| | and upper rim | |
| S (in) | Height between top of outer thread and | 0.096 |
| | upper rim | |
| I (in) | Inner diameter at side wall proximate the | 1.064 |
| | inner undercut | |
| C (in) | Inner diameter at inwardly-extending rib | 1.000 |

A first plastic preform was crystallized using a conventional plug. The conventional plug supported the preform at dimension C, i.e., the inner diameter at the height of the inwardly-extending rib, but did not provide support along the side wall proximate the inner undercut, for example, at dimension I. Table 2 compares the dimensions of the initial preform and the preform crystallized using the conventional plug, and further compares these dimensions to the nominal design specifications.

TABLE 2
(all units are in inches)

| | | | | Crystallized | | | Δ | Δ | Δ |
|---|---|---|---|---|---|---|---|---|---|
| | Amorphous | | | (Conventional Plug) | | | (Design to | (Amorph to | (Design to |
| Dimension | Avg. | S.D. | Range | Avg. | S.D. | Range | Amorph) | Crystal) | Crystal) |
| T-avg | 1.325 | 0.000 | 0.001 | 1.310 | 0.002 | 0.005 | −0.001 | −0.014 | −0.016 |
| T-ovality | 0.000 | 0.000 | 0.000 | 0.001 | 0.001 | 0.002 | 0.000 | 0.001 | 0.001 |
| E-avg | 1.227 | 0.000 | 0.001 | 1.210 | 0.002 | 0.005 | 0.001 | −0.017 | −0.016 |
| F-avg (E above T) | 1.222 | 0.001 | 0.001 | 1.220 | 0.002 | 0.006 | −0.004 | −0.002 | −0.006 |
| K-avg | 0.160 | 0.001 | 0.004 | 0.160 | 0.002 | 0.004 | 0.000 | 0.000 | 0.000 |
| Z-avg | 1.374 | 0.001 | 0.002 | 1.346 | 0.001 | 0.003 | 0.000 | −0.027 | −0.028 |
| H-avg | 0.246 | 0.000 | 0.001 | 0.240 | 0.001 | 0.002 | 0.003 | −0.006 | −0.003 |
| X-avg | 0.340 | 0.001 | 0.002 | 0.335 | 0.001 | 0.004 | 0.000 | −0.006 | −0.005 |
| S (in) | 0.102 | 0.000 | 0.001 | 0.099 | 0.000 | 0.001 | 0.006 | −0.003 | 0.003 |
| I (in) | 1.064 | 0.000 | 0.000 | 1.042 | 0.001 | 0.004 | 0.000 | −0.021 | −0.022 |
| C (in) | 1.003 | 0.002 | 0.005 | 1.007 | 0.002 | 0.005 | 0.003 | 0.004 | 0.007 |

A second plastic preform was crystallized using a plug in accordance with the disclosed subject matter and having a round O-ring made of silicone as the expandable ring, as shown schematically in FIG. 5. As illustrated in FIG. 5, the O-ring provided support at a point along the side wall proximate the inner undercut, i.e., at dimension I, while the upper plug member provided support at the inwardly-extending rib, i.e., at dimension C. Table 3 compares the dimensions of the initial preform and the preform crystallized using the round O-ring, and further compares these dimensions to the nominal design specifications.

TABLE 3
(all units are in inches)

| | | | | Crystallized | | | Δ | Δ |
|---|---|---|---|---|---|---|---|---|
| | Amorphous | | | (Plug with Round O-ring) | | | (Amorph to | (Design to |
| Dimension | Avg. | S.D. | Range | Avg. | S.D. | Range | Crystal) | Crystal) |
| T-avg | 1.326 | 0.000 | 0.001 | 1.316 | 0.004 | 0.014 | −0.010 | −0.010 |
| T-ovality | 0.000 | 0.000 | 0.001 | 0.004 | 0.003 | 0.007 | 0.003 | 0.004 |
| E-avg | 1.227 | 0.000 | 0.001 | 1.224 | 0.005 | 0.016 | −0.003 | −0.002 |
| F-avg (E above T) | 1.225 | 0.000 | 0.001 | 1.214 | 0.003 | 0.008 | −0.011 | −0.012 |
| K-avg | 0.161 | 0.001 | 0.003 | 0.156 | 0.003 | 0.008 | −0.005 | −0.004 |
| Z-avg | 1.374 | 0.000 | 0.001 | 1.356 | 0.003 | 0.010 | −0.019 | −0.018 |
| H-avg | 0.249 | 0.001 | 0.003 | 0.245 | 0.001 | 0.004 | −0.003 | 0.002 |
| X-avg | 0.343 | 0.002 | 0.005 | 0.339 | 0.001 | 0.004 | −0.004 | −0.001 |
| S (in) | 0.098 | 0.000 | 0.001 | 0.092 | 0.002 | 0.006 | −0.006 | −0.004 |
| I (in) | 1.073 | 0.000 | 0.001 | 1.066 | 0.006 | 0.019 | −0.007 | 0.002 |
| C (in) | 1.001 | 0.000 | 0.001 | 0.992 | 0.003 | 0.009 | −0.009 | −0.008 |

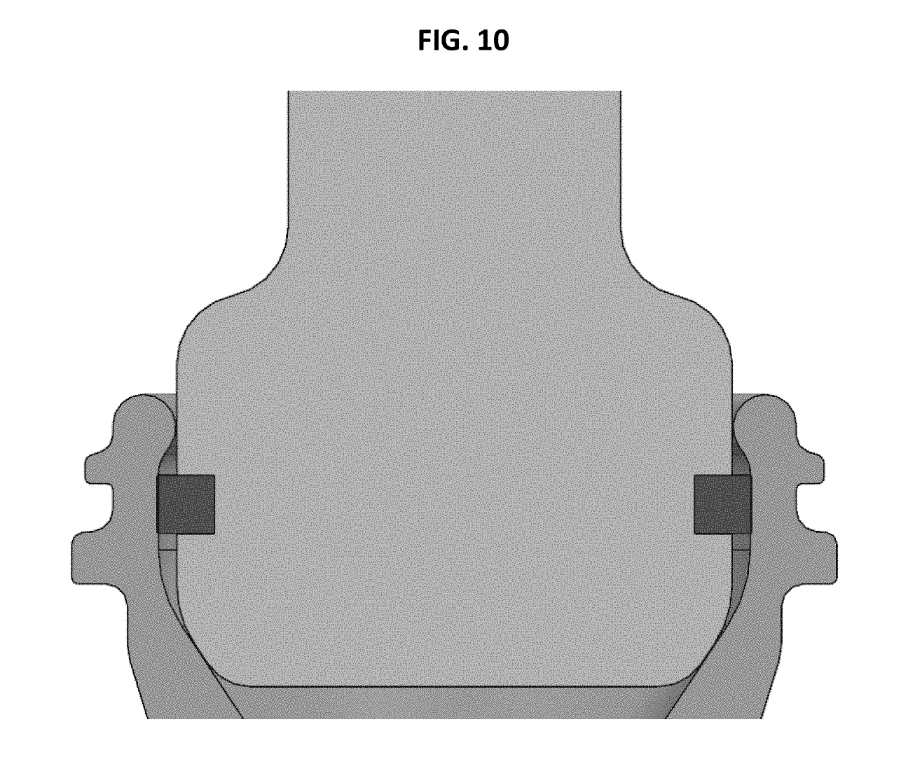

A third plastic preform was crystallized using a plug in accordance with the disclosed subject matter and having a square O-ring made of silicone as the expandable ring, as shown schematically in FIG. 10. As illustrated in FIG. 10, the square O-ring provided support along a length of the side wall proximate the inner undercut, i.e., at dimension I, while the upper plug member provided support at the inwardly-extending rib, i.e., at dimension C. Table 4 compares the dimensions of the initial preform and the preform crystallized using the square O-ring, and further compares these dimensions to the nominal design specifications.

TABLE 4
(all units are in inches)

| | | | | Crystallized | | | Δ | Δ |
|---|---|---|---|---|---|---|---|---|
| | Amorphous | | | (Plug with Square O-ring) | | | (Amorph to | (Design to |
| Dimension | Avg. | S.D. | Range | Avg. | S.D. | Range | Crystal) | Crystal) |
| T-avg | 1.326 | 0.000 | 0.001 | 1.318 | 0.005 | 0.014 | −0.007 | −0.008 |
| T-ovality | 0.000 | 0.000 | 0.001 | 0.004 | 0.003 | 0.007 | 0.004 | 0.004 |
| E-avg | 1.227 | 0.000 | 0.001 | 1.224 | 0.004 | 0.011 | −0.004 | −0.002 |
| F-avg (E above T) | 1.225 | 0.000 | 0.001 | 1.221 | 0.008 | 0.019 | −0.004 | −0.005 |
| K-avg | 0.161 | 0.001 | 0.003 | 0.159 | 0.003 | 0.006 | −0.003 | −0.001 |
| Z-avg | 1.374 | 0.000 | 0.001 | 1.359 | 0.003 | 0.007 | −0.016 | −0.015 |
| H-avg | 0.249 | 0.001 | 0.003 | 0.243 | 0.001 | 0.003 | −0.006 | 0.000 |
| X-avg | 0.343 | 0.002 | 0.005 | 0.336 | 0.002 | 0.004 | −0.006 | −0.004 |
| S (in) | 0.098 | 0.000 | 0.001 | 0.095 | 0.002 | 0.004 | −0.003 | −0.001 |
| I (in) | 1.073 | 0.000 | 0.001 | 1.067 | 0.006 | 0.015 | −0.006 | 0.003 |
| C (in) | 1.001 | 0.000 | 0.001 | 0.999 | 0.008 | 0.022 | −0.001 | −0.001 |

A fourth plastic preform was crystallized using a plug in accordance with the disclosed subject matter and having a hinged members, as shown schematically in FIGS. 7A-7D. Engagement ends of the hinged members provided support along a length of the side wall proximate the inner undercut, i.e., at dimension I. Table 5 compares the dimensions of the initial preform and the preform crystallized using the plug having hinged members, and further compares these dimensions to the nominal design specifications.

TABLE 5
(all units are in inches)

| | | | | Crystallized | | | Δ | Δ |
|---|---|---|---|---|---|---|---|---|
| | Amorphous | | | (Plug with Hinged Members) | | | (Amorph to | (Design to |
| Dimension | Avg. | S.D. | Range | Avg. | S.D. | Range | Crystal) | Crystal) |
| T-avg | 1.326 | 0.000 | 0.001 | 1.321 | 0.002 | 0.006 | 0.005 | 0.005 |
| T-ovality | 0.000 | 0.000 | 0.001 | 0.003 | 0.003 | 0.009 | −0.003 | −0.003 |
| E-avg | 1.227 | 0.000 | 0.001 | 1.225 | 0.002 | 0.006 | 0.002 | 0.001 |
| F-avg (E above T) | 1.225 | 0.000 | 0.001 | 1.226 | 0.002 | 0.009 | −0.001 | 0.000 |
| K-avg | 0.161 | 0.001 | 0.003 | 0.158 | 0.001 | 0.003 | 0.003 | 0.002 |
| Z-avg | 1.374 | 0.000 | 0.001 | 1.367 | 0.003 | 0.011 | 0.007 | 0.007 |
| H-avg | 0.249 | 0.001 | 0.003 | 0.238 | 0.001 | 0.004 | 0.011 | 0.005 |
| X-avg | 0.343 | 0.002 | 0.005 | 0.333 | 0.001 | 0.005 | 0.010 | 0.007 |
| S (in) | 0.098 | 0.000 | 0.001 | 0.099 | 0.001 | 0.002 | −0.001 | −0.003 |
| I (in) | 1.073 | 0.000 | 0.001 | 1.070 | 0.002 | 0.007 | 0.003 | −0.006 |
| C (in) | 1.001 | 0.000 | 0.001 | 1.001 | 0.003 | 0.011 | 0.000 | −0.001 |

As shown in Tables 3-5, the plastic preforms crystallized while engaged with the plugs in accordance with the disclosed subject matter had less deviation from the initial dimensions (amorphous or pre-crystallization), and less deviation from the nominal design specifications. In particular, the dimension I, corresponding to the inner diameter of the side wall proximate the inner undercut, varied by at most 0.007 inches as compared to the preform pre-crystallization when the preform was crystallized using the presently disclosed plug. In contrast, dimension I varied by 0.021 inches as compared to the preform pre-crystallization when the preform was crystallized using conventional methods.

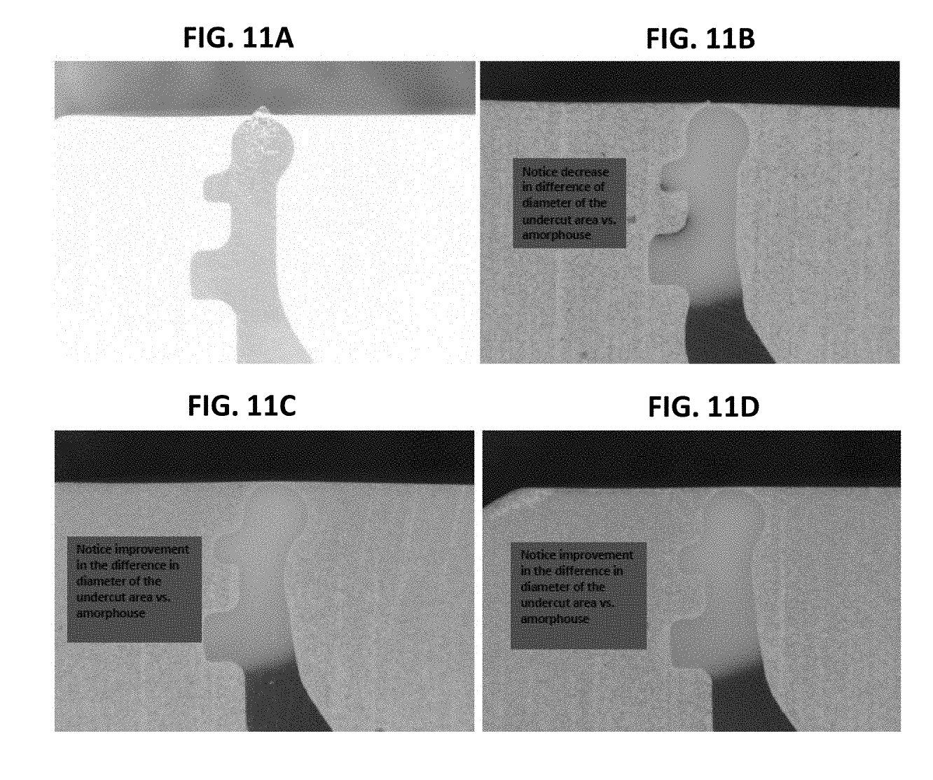

These results are further emphasized in FIGS. 11A-11D, which provide photographs of the preforms described in Tables 1-4, respectively. As illustrated in FIG. 11B, which corresponds to conventional crystallization methods, the inner diameter of the inner undercut significantly contracted as compared to the initial preform of FIG. 11A. However, the preforms of FIGS. 11C and 11D, corresponding to crystallization using plugs in accordance with the presently disclosed subject matter, generally maintained their original shape. As such, the presently disclosed devices and methods can be used effectively to maintain an inner diameter of a plastic container during fabrication.

### Example 2

In this Example, the compressibility of various materials was determined using a plug in accordance with the disclosed subject matter. Three different O-rings were fitted into a plug and compressed until reaching a target deployed outer diameter of 1.064 inches. Each of the O-rings had an average initial outer diameter in the range of 1.022 inches to 1.033 inches. The three O-rings were made of silicone, hard Viton™ rubber (The Chemours Company), and Viton™ rubber (The Chemours Company). The amount of compression required to achieve the target deployed outer diameter was determined as the difference in the average height of the O-ring prior to compression and the average height of the O-ring after compression. The results are provided in Table 6, below.

TABLE 6
(all units are in inches)

| | | | | |
|---|---|---|---|---|
| Diameter | Height | Diameter | Height | Amount of |
| (uncom- | (uncom- | (com- | (com- | Com- |
| pressed) | pressed) | pressed) | pressed) | pression |

Silicone O-Rings

| | | | | | |
|---|---|---|---|---|---|
| Average | 1.026 | 0.209 | 1.064 | 0.170 | 0.039 |
| Minimum | 1.023 | 0.207 | 1.064 | 0.165 | 0.037 |
| Maximum | 1.028 | 0.212 | 1.065 | 0.172 | 0.042 |
| Range | 0.005 | 0.005 | 0.001 | 0.007 | 0.005 |

Hard Viton ™ Rubber O-Rings

| | | | | | |
|---|---|---|---|---|---|
| Average | 1.026 | 0.211 | 1.064 | 0.170 | 0.040 |
| Minimum | 1.022 | 0.208 | 1.063 | 0.167 | 0.036 |
| Maximum | 1.033 | 0.213 | 1.065 | 0.175 | 0.045 |
| Range | 0.011 | 0.005 | 0.002 | 0.008 | 0.009 |

Viton ™ Rubber O-Rings

| | | | | | |
|---|---|---|---|---|---|
| Average | 1.027 | 0.208 | 1.064 | 0.170 | 0.039 |
| Minimum | 1.025 | 0.205 | 1.063 | 0.167 | 0.036 |
| Maximum | 1.029 | 0.212 | 1.065 | 0.174 | 0.043 |
| Range | 0.004 | 0.007 | 0.002 | 0.007 | 0.007 |

As shown in Table 6, depending on the material selected, the amount of compression required to achieve the desired deployed outer diameter was similar for each of the 3 materials tested, and the plug in accordance with the disclosed subject matter was able to deform the O-rings to the target specification. As such, these silicone and rubber materials are suitable for use as an expandable ring in a plug according to the disclosed subject matter.

While the disclosed subject matter is described herein in terms of certain preferred embodiments, those skilled in the art will recognize that various modifications and improvements can be made to the disclosed subject matter without departing from the scope thereof. Additional features known in the art likewise can be incorporated, such as disclosed in U.S. Patent Publication No. US2013/0082074, which is incorporated in its entirety by reference herein. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the various embodiments depicted and claimed, the disclosed subject matter is also directed to other embodiments having any other possible combination of the features disclosed and claimed herein. As such, the particular features presented herein can be combined with each other in other manners within the scope of the disclosed subject matter such that the disclosed subject matter includes any suitable combination of the features disclosed herein. Furthermore, although reference is made to a pressure container throughout this disclosure, a person of ordinary skill in the art will appreciate that the disclosed plug and methods can be used to maintain an inner diameter of any plastic container, and are not limited to pressure containers. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the device and methods of the disclosed subject matter without departing from the spirit or scope of the disclosed subject matter. Thus, it is intended that the disclosed subject matter include modifications and variations that are within the scope of the appended claims and their equivalents.

What is claimed is:

1. A method of manufacturing a plastic preform having an inner undercut, comprising:
forming a preform of plastic in amorphous state, the preform comprising a finish portion defining a mouth, the finish portion having a side wall with a first inner diameter in plan view and an inwardly-projecting rib with a second inner diameter in plan view less than the first inner diameter to define an inner undercut therebetween;
inserting a plug within the mouth of the preform, the plug having an initial condition and a deployed condition, wherein the plug comprises:
an upper plug member and an expandable element, the expandable element having an initial outer diameter in plan view with the plug in the initial condition and a deployed outer diameter in plan view with the plug in the deployed condition, the initial outer diameter being less than the second inner diameter and the deployed outer diameter being equal to or greater than the second inner diameter;
deploying the plug to the deployed condition with the expandable element positioned to engage the side wall proximate the inner undercut; and
crystallizing the plastic of the preform along the finish portion.

2. The method of claim 1, wherein the plug further comprises a shaft extending from the upper plug member, wherein the expandable element is disposed on the shaft.

3. The method of claim 1, wherein the expandable element comprises an expandable ring.

4. The method of claim 3, wherein the plug further comprises a lower plug member, the upper plug member and the lower plug member being moveable relative to each other, wherein the expandable ring is disposed so as to be compressed between the upper plug member and the lower plug member with the plug in the deployed condition.

5. The method of claim 1, wherein the expandable element comprises a plurality of hinged members disposed around a circumference of the expandable element and mounted for pivotal movement between an initial position and a deployed position, each hinged member having an engagement end and an actuation end, wherein the engagement ends of the hinged members collectively define a generally continuous surface having the deployed outer diameter.

6. The method of claim 5, wherein a first set of hinged members have engagement ends with outwardly tapered side surfaces and a second set of hinged members have engagement ends with inwardly tapered side surfaces to cooperate with the side surfaces of the first set of hinged members.

7. The method of claim 5, wherein an expandable ring is disposed over the engagement ends of the hinged members, the expandable ring defining the initial outer diameter with the plug in the initial condition and the generally continuous surface having the deployed outer diameter with the plug in the deployed condition.

8. The method of claim 1, wherein the inwardly-projecting rib is proximate an upper edge of the finish portion.

9. The method of claim 1, wherein the inner undercut has a depth defined between the first inner diameter and the second inner diameter.

10. The method of claim 1, wherein the inner undercut has a radiused surface extending from the side wall in cross sectional side view, and the expandable element has a corresponding radius in cross sectional side view with the plug in the deployed condition to engage the radiused surface.

11. The method of claim 1, wherein the inner undercut has a lower surface extending from and defining an angle relative to the side wall in cross sectional side view, and the expandable element has a corresponding angle in cross sectional side view with the plug in the deployed condition to engage the lower surface and the side wall.

12. The method of claim 1, wherein the plastic comprises polyethylene terephthalate (PET), polyethylene naphthalate (PEN), polyethylene furanoate (PEF), or a combination thereof.

13. The method of claim 1, wherein the upper plug member and the expandable element are each made of a material compatible with a pressure and a temperature used for crystallizing the plastic.

14. The method of claim 1, wherein the upper plug member comprises polyether ether ketone (PEEK), ultra-high-molecular-weight polyethylene, aluminum, and/or stainless steel.

15. The method of claim 3, wherein the expandable ring comprises rubber, silicone, or a combination thereof.

16. The method of claim 1, wherein the deployed outer diameter of the expandable element is at least equal to the first inner diameter.

17. The method of claim 1, wherein the plug further comprises a lower plug member.

18. The method of claim 17, wherein the preform further comprises a hollow body portion extending from the finish portion, the body portion having an inner cross dimension in plan view less than the first inner diameter; and further wherein at least a portion of the lower plug member extends into the hollow body portion when the plug is inserted into the mouth of the preform, the at least a portion of the lower plug member having an outer diameter less than the inner cross dimension.

19. The method of claim 1, wherein the side wall has a crystallized first inner diameter after crystallizing the plastic of the preform, the crystallized first inner diameter being within 10% of the first inner diameter before crystallizing the plastic.

20. A method of manufacturing a plastic container having an inner undercut, comprising:
forming a preform of plastic in amorphous state, the preform comprising a finish portion defining a mouth, the finish portion having a side wall with a first inner diameter in plan view and an inwardly projecting rib with a second inner diameter in plan view less than the first inner diameter to define a an inner undercut therebetween, the preform further comprising a hollow body portion extending from the finish portion;
inserting a plug within the mouth of the preform, the plug having an initial condition and a deployed condition, wherein the plug comprises:
an upper plug member and an expandable element, the expandable element having an initial outer diameter in plan view with the plug in the initial condition and a deployed outer diameter in plan view with the plug in the deployed condition, the initial outer diameter being less than the second inner diameter and the deployed outer diameter being equal to or greater than the second inner diameter,
deploying the plug to the deployed condition with the expandable element positioned to engage the side wall proximate the inner undercut;
crystallizing the plastic of the preform along the finish portion; and
blow molding the hollow body portion of the preform to form a container body portion.

21. The method of claim 20, wherein the side wall has a crystallized first inner diameter after crystallizing the plastic of the preform, the crystallized first inner diameter being maintained within 10% of the first inner diameter before crystallizing the plastic.

22. The method of claim 20, wherein the blow molding comprises a reheat stretch blow molding process.

23. The method of claim 20, further comprising securing a valve assembly to the finish portion in engagement with the inner undercut.

24. A plug for maintaining an inner diameter of a plastic container having an inner undercut during crystallization, comprising:
an upper plug member;
an expandable element having an initial outer diameter in plan view with the plug in an initial condition and a deployed outer diameter in plan view with the plug in a deployed condition, the initial outer diameter being less than the deployed outer diameter; and
an actuator to change the plug from the initial condition to the deployed condition;
wherein the upper plug member and the expandable element are each made of a material compatible with a temperature and a pressure used for crystallizing a plastic selected from the group consisting of polyethylene terephthalate (PET), polyethylene naphthalate (PEN), polyethylene furanoate (PEF), or a combination thereof.

25. The plug of claim 24, wherein the upper plug member has a shaft extending therefrom and the expandable element is disposed on the shaft.

26. The plug of claim 24, wherein the upper plug member comprises polyether ether ketone (PEEK), ultra-high-molecular-weight polyethylene, aluminum, and/or stainless steel.

27. The plug of claim 24, wherein the deployed diameter of the expandable element is greater than a maximum outer diameter of the upper plug member.

28. The plug of claim 24, wherein the deployed diameter of the expandable element is from about 0.05% to about 1% greater than the initial outer diameter.

29. The plug of claim 24, wherein the actuator comprises a drive mechanism selected from a cam member, an air cylinder, servo motor, thread assembly, a gear assembly, a hydraulic cylinder, or a pneumatic cylinder.

30. The plug of claim 24, wherein the expandable element comprises an expandable ring.

31. The plug of claim 30, wherein the expandable ring comprises rubber, silicone, or a combination thereof.

32. The plug of claim 30, further comprising a lower plug, the upper plug member and the lower plug member being moveable relative to each other, wherein the expandable ring is disposed so as to be compressed between the upper plug member and the lower plug member with the plug in the deployed condition.

33. The plug of claim 30, wherein the expandable element comprises a plurality of hinged members disposed around a circumference of the expandable element and mounted for pivotal movement between an initial position and a deployed position, each hinged member having an engagement end and an actuation end, wherein the engagement ends of the hinged members collectively define a generally continuous surface having the deployed outer diameter.

34. The plug of claim 33, wherein a first set of hinged members have engagement ends with outwardly tapered side surfaces and a second set of hinged members have engagement ends with inwardly tapered side surfaces to cooperate with the side surfaces of the first set of hinged members.

35. The plug of claim 33, wherein an expandable ring is disposed over the engagement ends of the hinged members, the expandable ring defining the initial outer diameter with the plug in the initial condition and the generally continuous surface having the deployed outer diameter with the plug in the deployed condition.
